(19) United States
(12) Patent Application Publication
(10) Pub. No.: US 2013/0173711 A1
(43) Pub. Date: Jul. 4, 2013

(54) PROFESSIONAL PORTFOLIO SHARING APPLICATION

(71) Applicant: Pier 59 Studios LP, New York, NY (US)

(72) Inventor: Federico Pignatelli, Beverly Hills, CA (US)

(73) Assignee: PIER 59 STUDIOS LP, New York, NY (US)

(21) Appl. No.: 13/776,197

(22) Filed: Feb. 25, 2013

Related U.S. Application Data
(63) Continuation of application No. PCT/US2011/049142, filed on Aug. 25, 2011.
(60) Provisional application No. 61/379,690, filed on Sep. 2, 2010.
(60) Provisional application No. 61/377,053, filed on Aug. 25, 2010.

(51) Int. Cl. H04L 29/08

(52) U.S. Cl. CPC H04L 67/22
USPC 709/204

(57) ABSTRACT

A product and a process enable a user of a computing device to produce, share, send, and/or view portfolios containing images, text, audio, and/or video. Portfolios may also be shared or pushed out to prospective clients, friends, interested parties, or customers.

### CROSS-REFERENCE TO RELATED APPLICATIONS

This is a continuation of International Application No. PCT/US2011/049142, filed Aug. 25, 2011, which claims the benefit of U.S. Provisional Application No. 61/379,690, filed Sep. 2, 2010 and U.S. Provisional Application No. 61/377,053, filed Aug. 25, 2010, all the above applications hereby incorporated herein by reference.

### BACKGROUND OF THE INVENTION

1. Field of the Invention

The present invention relates generally to computers and, more particularly, to computer systems for generating and maintaining information in the context of art-world portfolios for users in the arts and humanities pursuits.

2. Description of Related Art

Sets or groupings of individual pieces of creative work collected to be shown to potential customers or employers are portfolios. Humanities or art-world portfolios (hereafter “portfolios”) are commonly used by artists, authors, models, art-world companies, and others in the arts and humanities pursuits to promote the artistic abilities, capabilities, or products of individuals, groups, or companies. Portfolios are also viewed by employers seeking employees (e.g., art-world employees), and by customers looking for products with specific specifications or attributes.

Examples of portfolios include groups of photographs of a model seeking work, sets of information data sheets, photographs reviewing a company's product line, and recordings of music performed by an artist. A well prepared portfolio instantly communicates to a prospective employer or customer actual examples of the capabilities of a prospective employee or the products produced by a company. One look at a photograph of a model wearing attractive attire can be enough for a modeling agent to decide to hire a model. A quick review of a company's product portfolio is frequently enough for a prospective customer to decide if they should purchase a product or not.

Portfolios are commonly distributed in various formats that include yet are not limited to hardcopy books or fliers, recordings on compact disks, or digital renditions via the Internet. Portfolios however are not currently set up to be commonly distributed and shared between users of computing devices in a way designed to push in an effective manner creative content or products directly to employers or to customers.

Computing devices are known to include yet are not limited to personal computers, tablet computers, smart phones, iPhones, iPads, personal organizers, a computer server, or other electronic products that are capable of displaying, storing, or manipulation digital information.

Personal computing devices include yet are not limited to personal computers, tablet computers, smart phones, iPhones, iPads, personal organizers, and other electronic products that belong to an individual user that are capable of displaying, storing, and manipulating digital information.

By any interpretation, personal computing devices have become indispensable for their ability as tools to communicate data, text, images, audio, and video over the Internet and/or data communication networks. Program applications are available for purchase today that run on miniaturized computing devices, most of which are driven by mobile applications and communicate with computing devices that reside on the Internet. Examples of mobile applications include text messaging, mobile television, games, custom ring tones, and encryption software. Computing devices and program applications however are not ubiquitously designed to push portfolios containing creative content or products directly to employers or customers in a highly structured and effective way. A system that enables individuals, groups, and companies to create and share portfolios directly with those seeking alliances, employees or products would be of great benefit to promoters, consumers and job seekers, as it could promote distribution of the most relevant information instantly to select audiences with increased efficacy and reduced cost.

### SUMMARY OF THE INVENTION

The invention pertains to computer systems for generating and maintaining enriched databases for users and to apparatuses and methods for enhanced promotion of associated portfolio products.

An embodiment of the invention is implemented as a web-based virtual portfolio generator and manager, or coordinator, comprising an input adapted to receive input data through a computer network from at least one connected user operating a client computer.

In one aspect, the web-based virtual portfolio coordinator includes software adapted to effectuate accessing, updating and/or generating a first vector or file of subject-customized descriptors describing at least a feature, characteristic or accomplishment of a subject, the first vector being constructed according to the input data received from the user. The embodiment, further, comprises a database accessible to the client computer, the database comprising at least a second vector or file of subject-customized descriptors describing at least an additional feature, characteristic or accomplishment of the subject, the second vector being constructed according to the same or additional input data received from the user. Furthermore, one or more additional features, characteristics or accomplishments of the subject may exist or be constructed via means such as one or more additional vectors or files. An embodiment may comprise one or more additional databases, and/or the same database, accessible to the client computer and comprising a plurality of records, with one or more of the records corresponding to one or more portfolios and/or vectors. Information used to cross reference attributes of a portfolio to users who have access to view a portfolio utilizing a database is an example of one or more vectors consistent with an embodiment of the present invention. Vectors can include yet are not limited to lists of who can view a particular portfolio or who can edit a particular portfolio.

While the apparatus and method has or will be described for the sake of grammatical fluidity with functional explanations, it is to be expressly understood that the claims, unless indicated otherwise, are not to be construed as limited in any way by the construction of “means” or “steps” limitations, but are to be accorded the full scope of the meaning and equivalents of the definition provided by the claims under the judicial doctrine of equivalents.

Any feature or combination of features described or referenced herein are included within the scope of the present invention provided that the features included in any such combination are not mutually inconsistent as will be apparent from the context, this specification, and the knowledge of one skilled in the art. In addition, any feature or combination of features described or referenced may be specifically included, replicated and/or excluded, in any combination, in/from any embodiment of the present invention. For purposes of summarizing the present invention, certain aspects, advantages and novel features of the present invention are described or referenced. Of course, it is to be understood that not necessarily all such aspects, advantages or features will be embodied in any particular implementation of the present invention. Additional advantages and aspects of the present invention are apparent in the following detailed description and claims that follow.

### BRIEF DESCRIPTION OF THE DRAWINGS

FIG. 1 illustrates a personalized computer system in accordance with an embodiment of the present invention;

FIG. 2 illustrates a system diagram illustrating a number of components in accordance with an embodiment of the present invention; and

FIG. 3 illustrates a process diagram illustrating features and functions of two program applications in accordance with an embodiment of the present invention.

### DETAILED DESCRIPTION OF THE INVENTION

Embodiments of the invention are now described and illustrated in the accompanying drawings, instances of which are to be interpreted to be to scale in some implementations while in other implementations, for each instance, not. In certain aspects, use of like or the same reference designators in the drawings and description refers to the same, similar or analogous components and/or elements, while according to other implementations the same use should not. According to certain implementations described or referenced herein, use of directional terms, such as, top, bottom, left, right, up, down, over, above, below, beneath, rear, and front, are to be construed literally, while in other implementations the same use should not. The present invention may be practiced in conjunction with various programming languages and communication protocols and file formats including yet not limited to HTTP, XML, HTMP, JPG, TIFF, DOC, or other techniques that are conventionally used in the art, and only so much of the commonly practiced process steps and features are included herein as are necessary to provide an understanding of the present invention.

The present invention has applicability in the field of computer network data communication and processes such as in the context of arts and humanities in general. For illustrative purposes, however, the following description pertains to a product and process for creating and sharing portfolios (i.e., art-world portfolios) over an openly-shared data communication network such as the Internet.

The term “access rights to individual portfolios” is used below in accordance with the following: Access rights to individual portfolios include the right to edit a portfolio and/or the right to view a portfolio such as for example by way of vectors used to manage portfolios. Each portfolio may be edited by its creator or by an authorized editor. The creator or authorized editor of a portfolio may extend viewing rights to other users by updating a portfolio sharing list on a portfolio web application.

The phrase “authorized users” is used herein according to the following: Authorized users are users of program applications consistent with embodiments of the invention that include yet are not limited to portfolio individual mobile applications and portfolio web applications that have the right to edit a particular portfolio or view a particular portfolio.

The term “program application” is used below in accordance with the following: A program application is a set of code or instructions capable of running discrete logical commands on a computing device.

The words “computing device(s)” are used herein according to the following: They include yet are not limited to personal computers, tablet computers, smart phones, iPhones, iPads, personal organizers, computer servers, and other electronic products that are capable of displaying, storing, and/or manipulation digital information.

The phrase “digital content” is used below in accordance with the following: Such items include yet are not limited to one or more images, text, audio, video (e.g., as used below) and/or video data.

The term “invitation lists” is used herein according to the following: Invitation lists are lists of users or user groups to which an invitation to view a portfolio will be sent, or to the users or user groups to which a portfolio will be sent.

As used herein, “Internet connection or data communication network” can be construed in accordance with the following: These terms relate to various channels or technologies employed to communicate with an Internet, intranet, web, or world wide web type of communication channel including yet not limited to a DSL connection, telephone modem, cable modem, cellular telephone network, WIFI network, or satellite data communication network.

The label “portfolio individual mobile application” is used herein according to the following: It can refer to a first program application running on a personal computing device that can communicate with a second program application, such as a portfolio web application to create and manage (or to facilitate the creation and management of) digital portfolios.

The label “portfolio web application” is used below in accordance with the following: It can refer to a second program application running on the Internet or on an intranet that can communicate with one or more portfolio individual mobile applications to create and manage (or to facilitate the creation and management of) digital portfolios.

The language “operating on the Internet” is used herein according to the following: The term relates to a program application executing discrete logical commands on a computing device accessible to users via the Internet, intranet, web, or data communication channel.

The term “personal computing device” is used below in accordance with the following: It can include yet is not limited to personal computers, tablet computers, smart phones, iPhones, iPads, personal organizers, or other electronic products that belong to an individual user and are capable of displaying, storing, or manipulating digital information.

The phrase “portfolio access privileges” is used herein according to the following: Portfolio access privileges are a cross reference that correlates a user's or a user groups' access rights to a portfolio. One or more users or user groups may have viewing and editing privileges where others only have viewing privileges.

The words “portfolio creative content” is used below in accordance with the following: The content can refer to a collection of digital content in an arrangement of pages organized in a unique fashion.

The term “portfolio” is used herein according to the following: Sets or groupings of individual pieces of creative work can be collected to be shown to potential customers or employers in the form of a portfolio.

The phrase “portfolio sharing lists” is used below in accordance with the following: A portfolio sharing list is a list of users or user groups who are authorized to view a portfolio.

The term “web application” is used herein according to the following: A web application is a program application operating or running on one or more computing devices that are accessible via the Internet, intranet, web, or data communication channel.

The invention is a product and a process that enables a user of a computing device to produce, share, send, and/or view (or to facilitate production, sharing, sending, and/or viewing of) portfolios containing images, text, audio, and/or video. The creation and sharing of portfolios in a digital format are accordingly objectives of the invention.

The invention utilizes one or more program applications that enable a user to create and manage, or to facilitate the creation and management of, a portfolio on one computing device and share it with other computing devices over an Internet connection or a data communication network.

Once installed or downloaded on a computing device, a program application is used by an individual to arrange digital content to create a portfolio. Digital content includes yet is not limited to one or more of images, text, audio, and video data on or associated with one or more pages of a portfolio. For example a user may use his or her smart phone to add a plurality of photographs and text to a portfolio page and then share, send, or save that portfolio page to others over the Internet.

Minimally there is one program application running on a client device used to create or control the creation of a portfolio. This first program application communicates with another, or second, program application that operates on the Internet or data communication network. The first program application will be exemplified in this document as an individual mobile application or portfolio individual mobile application. The second program application will be exemplified as a web application or portfolio web application.

The portfolio individual mobile application minimally has the capability of creating or controlling the creation of a portfolio using a user's computing device. Other features and capabilities that the portfolio individual mobile application may include are browsing/viewing available portfolios, inviting individuals to view a portfolio, and/or creating share permission lists that control which users can see a portfolio. Features and/or capabilities are not limited to those stated above and may include any set or subset of the features and/or capabilities that facilitate the creation and sharing of portfolios over an Internet connection or data communication network.

The portfolio web application minimally has the ability to store a plurality of individual portfolios and share portfolios with authorized users on their computing devices by sending data over the Internet or over a data communication network. Other features and capabilities that the portfolio web application may include or utilize are user profiles, account payment information, company information, user preferences, sending invitations to view portfolios, administrating portfolio viewing and editing privileges, and/or saving portfolios. Features and/or capabilities are not limited to those stated above and may include any set or subset of the features and/or capabilities that facilitate the creation and sharing of portfolios over an Internet connection or data communication network.

In one embodiment the portfolio individual mobile application controls the creation of portfolios on the portfolio web application. In this instance photos, text, audio, and/or video are uploaded and arranged on portfolio pages through the portfolio web application using an Internet connection or data communication network. In this embodiment portfolios may be created on the Internet, for example, by remote control.

In another embodiment the portfolio individual mobile application itself is used to create portfolios on an individual's client device that would later be uploaded to the portfolio web application using an Internet connection or a data communication network. In this embodiment portfolios can be created locally, for example, and then uploaded to the Internet.

The invention is thus a product and a process that enables a user of a computing device to create portfolios, share those portfolios, and, optionally, according to an embodiment or feature, push those portfolios in controlled ways to authorized users or user groups.

A fair statement from these features is that the invention generally pertains to computer systems for generating and maintaining databases for users and to apparatuses and methods for promoting portfolio products.

One contemplated embodiment of the invention is implemented in the context of a web-based virtual portfolio generator and manager, or coordinator, comprising an input adapted to receive input data through a computer network from a number of connected users operating client computers.

In one aspect, a web-based virtual portfolio coordinator includes software adapted to effectuate accessing, updating or generating a first vector or file of subject-customized descriptors describing at least a feature, characteristic or accomplishment of a subject, the first vector being constructed according to input data received from the subject or a user. The embodiment, further, comprises a database accessible to a client computer, the database comprising at least a second vector or file of subject-customized descriptors describing at least an additional feature, characteristic or accomplishment of the subject, the second vector being constructed according to input data received from the subject or user. Furthermore, one or more additional features, characteristics or accomplishments of the subject may exist or be constructed in a similar fashion. The embodiment may also comprise a database, or the same database, accessible to the client computer, the database comprising a plurality of records, each of the records corresponding to one or more portfolios and/or vectors.

Information used to cross reference attributes of a portfolio to users who have access to view a portfolio utilizing a database is an example of one or more vectors consistent with an embodiment of the present invention. Vectors include yet are not limited to lists of who can view a particular portfolio or who can edit a particular portfolio.

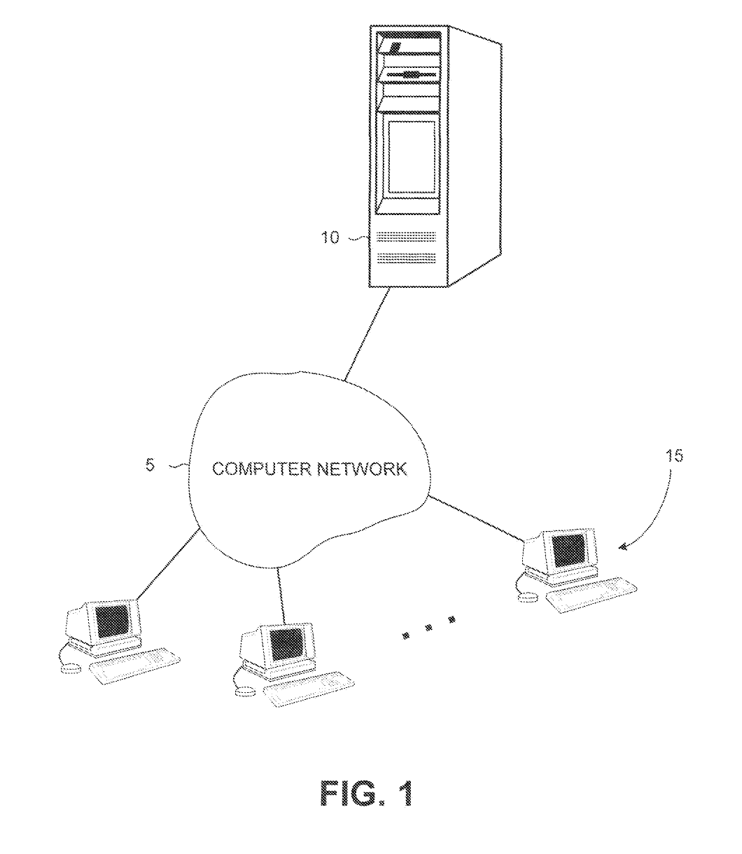

Referring now to FIG. 1, there is shown a schematic diagram of a network 5 in accordance with the present invention. The network 5 can be an Internet, Intranet, local area network, or any other medium for allowing at least one server 10 to communicate with at least one client 15. In the exemplary illustration, a server 10 communicates through the network 5 with a plurality of clients 15. The basic architectures of the server 10 and the clients 15 are preferably those well known in the art, such as, for example, computers having Intel Corporation (Santa Clara, Calif.) microprocessors and running Microsoft Corporation (Redmond, Wash.) Windows operating systems. The network 5 may include hubs, routers and other network devices (not shown).

By way of definition, a “server” refers to a computer that controls access to file and disk resources, such as multi-media (e.g., video) presentations on a network and provides security and synchronization on the network through a network operating system. The server hardware and/or software may provide services to other hardware and/or software. A “client” refers to a client computer that routes user (e.g., customer) commands either to a local operating system or to a network interface adapter for processing and transmission on the network 5. A client may function as a server by including appropriate software, and may be for example, an archive server or a communication server.

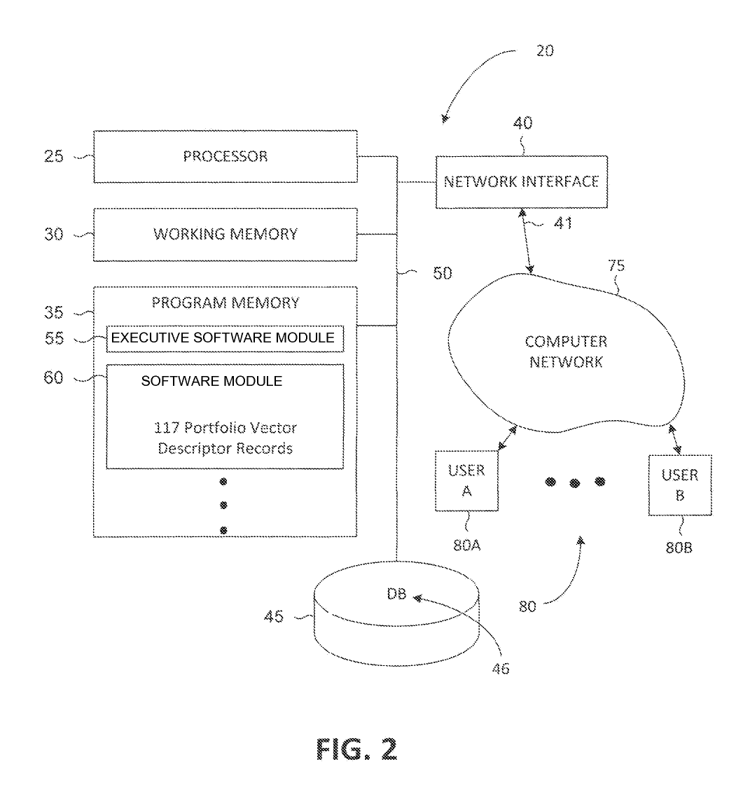

FIG. 2 is a block diagram of one particular implementation of an apparatus adapted to perform functions according to the present invention. The illustrated embodiment comprises a server 20 including at least one processor 25 (some embodiments may employ multiple processors), working memory 30, program memory 35, and a network interface 40 having an input port 41. The illustrated embodiment further comprises a database 46, which may be stored, for example, on a hard disk 45, and a system bus 50 that communicatively interconnects the aforementioned elements. The program memory 35 may have stored therein software modules including an executive software module 55, a user-descriptor software module 60, and other software modules (not shown) including, for example, a database software module, an accounting software module, an operating system software module, and the like. The server 20 in the illustrated embodiment may communicate with client computers 80, e.g., client computer 80A or client computer 80B, through a computer network 75 and may receive input data from one of the client computers 80 through, for example, the input port 41. The computer network 75 may comprise, for example, an Internet, an intranet, a local area network, or the like.

According to one exemplary operating mode of the server 20 shown in FIG. 2, the server 20 is adapted to receive input through the computer network 75 from at least one connected user operating one of the client computers, such as client computer 80A. The input may be selected, for example, from a list of possible commands communicated by the server 20 to the user subsequent to the user's signing-in to a web site supported by the server 20. According to a typical embodiment, the user may click on a command such as “CREATE PERSONAL PORTFOLIO.” Subsequently, the server 20 may communicate with the user through the network 75 and the client computer to receive additional commands through which the server 20 receives, for example, unique information of the user. In accordance with one embodiment, the user may be prompted to upload a photograph or particular type of information known to be relevant to the generation of a portfolio.

The database 46 is accessible to the server 20 and, consequently, additionally, and/or alternatively, may be accessible to the client computers 80. The database 46 may contain a plurality of records, at least one of which may include information according to the user. An example of a file that may be created and maintained in the database 46 by the server 20 according to data received from a user can include a field for a user number or identification datum that may identify the user along with a sign-in field containing a user name, password, and the like. The database 46, further, may comprise (1) a record or records of subject-customized descriptors, the record(s) of subject-customized descriptors potentially comprising sets (e.g., vectors) of text and/or images describing one or more of a feature, characteristic or accomplishment of a subject (who may be a user, contact, or the like), and (2) vectors associated with various items of the portfolio.

The file still further may comprise records corresponding to or comprising, for example, a plurality of graphic images relating to portfolio items in addition to optional corresponding portfolio vectors. A plurality of accessory records, further, may be included, which records may contain, for example, graphical images of ancillary items. Additionally, a user profile record may contain, for example, fields for storing personal preferences, a list of historical activities and/or purchases, and/or financial information. Alternative embodiments of the user profile record may, further, comprise a list of materials to which the user may have a particular affinity or aversion. The file, further, may comprise a registry area in which is maintained a list that may include specialty, desired or other of-interest items according to the user.

According to a typical embodiment of the server 20 illustrated in FIG. 2, the software module 60 may cause the processor 25 to access or update an existing set of portfolio vectors, which may be stored, for example, in a plurality of descriptor records; identified in FIG. 2 as 117 portfolio vector descriptor records. If such a vector(s) does not already exist, then the software module 60 may cause the processor to generate such a vector or vectors. In either case, the software module 60 effectuates the accessing, updating, and/or generating of a set of portfolio vectors. Minimally portfolio vectors link access rights to view or edit particular portfolios with authorized users. A portfolio vector descriptor record therefore minimally correlates who has access to view or edit individual portfolios.

According to an aspect of the present invention, the server 20 may transmit the image (e.g., or information sufficient for generation of the image) of an invitation to view a portfolio to a client computer where a user of the client computer may view the portfolio on a customary display screen that may form a portion of the client computer. Alternatively, or additionally, for example, a unique set of photographs contained within a portfolio combined with placement information may be transmitted to a user where a program application on the client computer generates a portfolio by placing each photograph in its intended location in the portfolio when displayed.

The server 20, further, may transmit one or more of a plurality of portfolios or portfolio items and reference information regarding a portfolio including, for example, information relating to shared portfolios or invitations to others to view a portfolio.

The user may select one of the plurality of images, which selection may be received by the server 20. The server 20 then may create an image of a portfolio and may transmit the image to the client computer for display to the user.

When a user selects a particular item of a portfolio, the software module 60 (FIG. 2) may, according to one embodiment, cause the processor 25 to retrieve from the database 46 one or more vectors relating to the selected portfolio item.

The invention utilizes one or more program applications that enable a user to create a portfolio on one computing device and share it with other computing devices over an Internet connection or a data communication network. Once installed or downloaded on a computing device, a program application is used by an individual to arrange digital content to create a portfolio. Digital content includes yet is not limited to one or more images, text, audio, and/or video data that may be associated with one or more pages of a portfolio. For example a user may use his or her smart phone to add a plurality of photographs and text to a portfolio page and then share, send, or save that portfolio page to others over the Internet. Minimally there is one program application running on a client device used to create or control the creation of a portfolio.

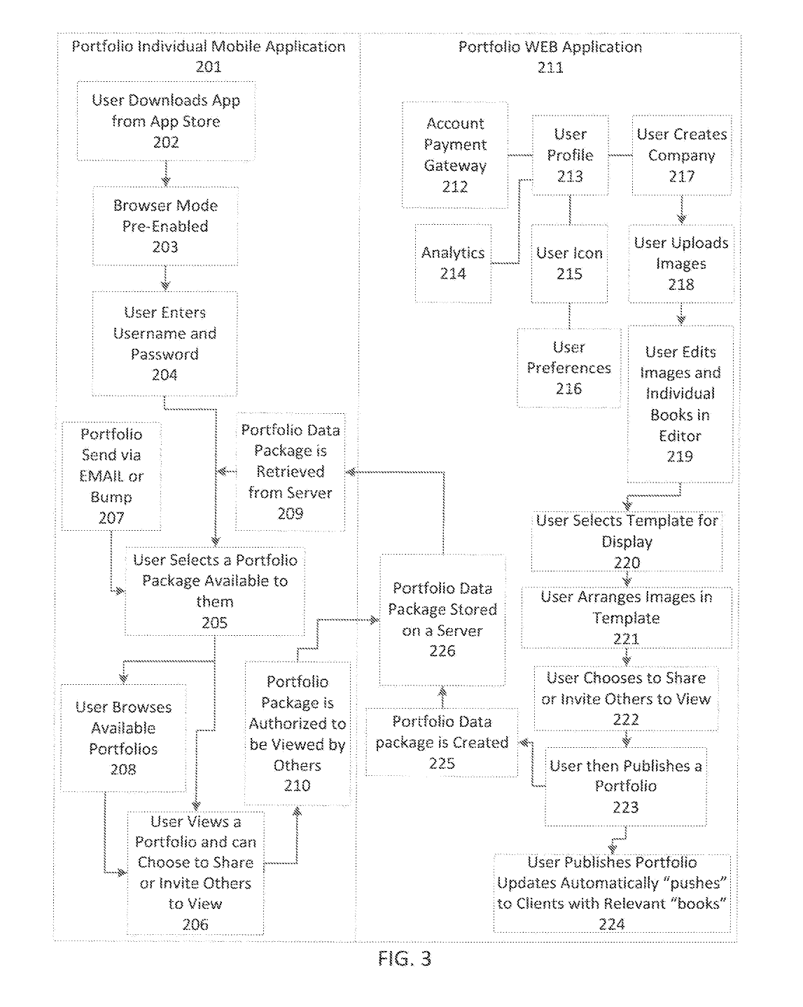

FIG. 3 shows an embodiment of the invention where a first program application running on a client device communicates with another program application that operates on the Internet or on an intranet, the first program application being referred to as an individual mobile application or portfolio individual mobile application 201 and the second program application being referred to as a web application or portfolio web application 211.

The portfolio individual mobile application minimally has the capability of creating or controlling the creation of a portfolio using a user's computing device. Other features and capabilities that the portfolio individual mobile application may include are browsing/viewing available portfolios, inviting individuals to view a portfolio, and/or creating other vectors that include yet are not limited to share permission lists that control which authorized users can view a portfolio. The portfolio web application minimally has the ability to store a plurality of individual portfolios and share portfolios with authorized users on their computing devices by sending data over the Internet or over a data communication network. Other features and capabilities that the portfolio web application may include are user profiles, account payment information, company information, user preferences, sending invitations to view portfolios, administrating portfolio viewing and editing privileges, and/or saving portfolios. Features and/or capabilities may include any set or subset of the features and/or capabilities that facilitate the creation and sharing of portfolios over an Internet connection or data communication network.

The portfolio individual mobile application and the portfolio web application configure and administrate the creation and sharing of portfolios through, for example, vectors defined by users to create, share, and invite others to view or manipulate portfolios.

According to FIG. 3, the portfolio individual mobile application 201 can contain various steps as reviewed below: A user can download an application from an application store 202, which can be enacted via downloading of the portfolio individual mobile application onto a computing device. A browser mode pre-enabled 203 is a setting enabling the portfolio individual mobile application 201 to communicate with the portfolio web application 211. When browser mode is enabled a user of the portfolio individual mobile application 201 may communicate with the portfolio web application 211. A user enters his or her username and password at 204. In a typical embodiment of the invention a user must enter a valid username and password to gain access to view or edit a portfolio. Individuals who do not have a username and valid password will be denied access to view or edit portfolios. The user selects a portfolio package available to him or her at 205, this being where the user selects a portfolio to view or edit.

A user viewing a portfolio can choose to share or invite others to view it at 206. In this step a user sets up the portfolio individual mobile application 201 sharing permissions and invitations that define who may view or be invited to view an individual portfolio. Sharing permissions and invitations can be embodied as vectors or portions of vectors used to authenticate users and cross reference their access rights. Only users with appropriate access privileges will be allowed to view or edit individual portfolios.

A portfolio send function via email or bump can be performed at 207, whereby portfolio invitations and portfolios themselves may be sent by email or bumped using this setting. Bumping can comprise the posting of a reply on an Internet forum intended to raise the priority of a thread. The priority of an invitation can thus be increased by bumping. Email and bumping are mechanisms that may be used to push portfolios to individuals or groups with which a user wishes to share a portfolio. A user may browse available portfolios at 208 whereby the user reviews portfolios for viewing or editing. Similar to browsing the Internet and linking to a web page, an authorized viewer may view a plurality of items by clicking on them or by selecting them. A portfolio data package may be retrieved from the server at 209, the step being performed for instance by the server receiving data from the portfolio web application 211 at step 226, with the portfolio data package being stored on a server 226. Here the portfolio individual mobile application 201 operating on a personal computing device communicates with the portfolio web application 211 residing on a server and operating on the Internet, intranet, or data communication network. A portfolio package may be authorized to be viewed by others at 210. This can be a final step in the exemplified summary of a portfolio individual mobile application 201 corresponding to that depicted in FIG. 3. Namely, in the process it communicates with portfolio web application 211 at step 226, the portfolio data package being stored on a server 226.

FIG. 3 also depicts an embodiment of the invention in the form of a portfolio web application 211. Here, the portfolio web application 211 contains various steps and features that are reviewed below, beginning with an account payment gateway 212 being shown to contain information relating to payments for using portfolio individual mobile application 201 and portfolio web application 211. A user profile 213 can contain information relating to particular user(s); it may contain information such as name, location, contact information or other personal information. Analytics 214 can contain information relating to a particular user's activities, behavior, preferences or habits, such as whether a particular user usually only creates and shares portfolios or whether a particular user typically only views portfolios produced by others. User icon 215 is a reference to an icon identifying one or more specific users or their portfolios. Instead of using text to identify a particular user or portfolio, an icon can be used to identify a particular user or portfolio.

The user preferences block 216 can contain information about a particular user's preferences for/to the portfolio individual mobile application 201 or portfolio web application 211 functions. Here, for example, users can change settings that affect the look and feel of their interface. A user can create his or her company at 217; for instance when creating a company a user may select portfolios he or she might like to view or edit.

At 218 a user can upload images to the portfolio web application 211; an execution of this process step enables new images to be incorporated into a portfolio web application. For example, a user may upload digital content or portfolios themselves by using his or her portfolio individual mobile application 201 communicating with a portfolio web application 211. User edits to images and individual books can be performed in editor 219, here for example a user who is remotely creating portfolio pages may add, delete, or modify content that has been uploaded to the portfolio web application 211 at an earlier time.

In process step 220 a user selects a template for display, whereby the user may choose what template or border a particular portfolio will contain. Template examples can include decorative designs and colors, contain promotional references or logos, or simply have plain borders. At step 221a user arranges images in the template, whereby the user may move images in a template or change what images are included in a particular page of a portfolio.

In accordance with step 222 the user may choose to share or invite others to view information, whereby for instance the user may set up who a portfolio may be shared with and to whom invitations to view a portfolio are to be sent. At step 223 the user may select to publish a portfolio, whereby the user may initiate the storage of a portfolio and/or retrieval or location thereof and allow it to be shared with authorized users.

Process step 224 comprises a user publishing portfolio updates by automatically “pushing” information to client(s) with relevant “books”; in one implementation, a user may set portfolio updates to be pushed to clients or friends with appropriate portfolio access privileges. Each time a user updates a particular portfolio (a book) it may be shared with specific users. Pushing a portfolio may in one implementation include sending invitations to view a portfolio or sending a portfolio itself to a set of predetermined individuals or groups.

In process step 225, a portfolio data package is created 225; here, digital data related to a portfolio can be prepared for storage. Per step 226 a portfolio data package can be stored on a server 226; for instance, portfolios may actually be stored on a server or data repository. This process step also is depicted in the context of communicating with portfolio mobile application 201 process steps 209 where a portfolio package is retrieved from a server, and 210 where the portfolio package is authorized to be viewed by others. This figure constitutes the process step of a portfolio data package stored on a server 226 communicating data to the portfolio individual mobile application 201 and the portfolio web application 211 administrating access to portfolios by other users.

FIG. 3 is one embodiment of the invention; slight modifications of the process steps contemplatable to those skilled in the art are considered alternate embodiments of the invention. Alternate embodiments of the invention may also have some process steps implemented in the portfolio individual mobile application 201 that are depicted in FIG. 3 as being implemented by the portfolio web application 211. Alternatively, functions depicted in FIG. 3 as being part of the portfolio web application 211 may be implemented in the portfolio individual mobile application 201. Alternate embodiments of the invention may contain fewer or additional steps than those depicted in FIG. 3 as the invention relates to the product and process for creating portfolios containing digital information that are shared to authorized users through a web application.

In one embodiment the portfolio individual mobile application 201 controls the creation of portfolios on the portfolio web application 211 whereby for instance photos, text, audio, and/or video are uploaded and arranged on portfolio pages through the portfolio web application 211 using an Internet connection or data communication network. In one such embodiment portfolios may for example be created on the Internet, intranet, or data communication network by remote control. FIG. 3 is an example of an embodiment of the invention where portfolios are created on the web by a program application residing on a computing device.

According to another embodiment the portfolio individual mobile application 201 itself can be used to create portfolios on an individual's client device that would later be uploaded to the portfolio web application 211 using an Internet connection, intranet connection, or some other data communication network. In an exemplary embodiment portfolios are created locally and then uploaded to the portfolio web application 211 residing on the Internet or intranet. Here, the program application running on a computing device may be configured to be more complex as it is used to create portfolios.

Audio and/or video may be embedded within or connected to a portfolio page, whereby clicking on an icon, a play button, or on an image would on some portfolio pages enable playing of digital audio content and/or video content. In this way motion and timing may be added to a portfolio. According to a primary feature, emphasis, preferred implementation and/or embodiment of the invention, the video can comprise one or more of still frame, slow motion, variable speed, a combination/blend/mix of any of the preceding, or any other form of digitally coded video and/or media known to those (e.g., artists) in the industry of art and/or the arts, including but not limited to categories known as the art world, passion world, photography world, and art science and its/their overlap with any one or more of the preceding.

The invention is thus a product and a process that enables a user of a computing device to create portfolios, share those portfolios, and, optionally, push those portfolios in controlled ways only to authorized users or user groups.

Corresponding or related structure and methods disclosed or referenced herein and/or in any and all co-pending, abandoned or patented application(s) by any of the named inventor(s) or assignee(s) of this application and invention, are incorporated herein by reference in their entireties, wherein such incorporation includes corresponding or related structure (and modifications thereof) which may be, in whole or in part, (i) operable and/or constructed with, (ii) modified by one skilled in the art to be operable and/or constructed with, and/or (iii) implemented/made/used with or in combination with, any part(s) of the present invention according to this disclosure, that of the application and references cited therein, and the knowledge and judgment of one skilled in the art.

Although the disclosure herein refers to certain illustrated embodiments, it is to be understood that these embodiments have been presented by way of example rather than limitation. Corresponding or related structure and methods specifically contemplated, disclosed and claimed herein as part of this invention, to the extent not mutually inconsistent as will be apparent from the context, this specification, and the knowledge of one skilled in the art, including, modifications thereto, which may be, in whole or in part, (i) operable and/or constructed with, (ii) modified by one skilled in the art to be operable and/or constructed with, and/or (iii) implemented/made/used with or in combination with, any parts of the present invention according to this disclosure, include: (I) any one or more parts of the above disclosed or referenced structure and methods and/or (II) subject matter of any one or more of the following claims and parts thereof, in any permutation and/or combination include the subject matter of any one or more of the following claims, in any permutation. The intent accompanying this disclosure is to have such embodiments construed in conjunction with the knowledge of one skilled in the art to cover all modifications, variations, combinations, permutations, omissions, substitutions, alternatives, and equivalents of the embodiments, to the extent not mutually exclusive, as may fall within the spirit and scope of the invention as limited only by the appended claims.

1. A method performed by a portfolio management application executed by a computing device, the method comprising:
receiving, from a user:
a portfolio of items of artistic work, to be stored by the computing device,
a designation of invitees that are to be invited to view the portfolio, and
a designation of which, of the invitees, are to have authorization to edit a copy of the portfolio stored by the application;
storing, on the computing device, a copy of the portfolio, the designation of invitees and the designation of which of the invitees have the authorization; and
sending, to each invitee, an invitation to view the selected portfolio.

2. The method of claim 1, further comprising:
sending, to each invitee each time the stored copy of the portfolio is updated, a portfolio update.

3. The method of claim 2, further comprising:
receiving, over the network from a viewer from among the invitees, a selection of the portfolio and an identification of additional invitees to be invited to view the portfolio;
enabling the viewer to view the selected portfolio; and
sending, to each additional invitee, an invitation to view the portfolio.

4. The method of claim 3, further comprising:
determining whether the viewer has the authorization to edit the stored copy of the portfolio; and
based on determining that the viewer has the authorization, enabling the viewer to edit the stored copy of the portfolio and to identify additional invitees to have the authorization.

5. The method of claim 4, further comprising:
receiving, over the network from an additional viewer who is among the additional invitees, a selection of the portfolio;
enabling the additional viewer to view the portfolio; and
based on determining the additional viewer has the authorization, enabling the additional viewer to edit the stored copy of the portfolio and to designate yet additional viewers to have the authorization.

6. The method of claim 4 wherein the computing device is a personal computing device operated by the user.

7. The method of claim 4 wherein the computing device is a server that communicates with the user over a communication network.

8. The method of claim 4 wherein the application communicates with the viewer through communication over a communication network with a personal computing device of the viewer.

9. The method of claim 8 wherein the viewer has the authorization, and the method further comprising:
the viewer bumping a personal computing device of the viewer to a further personal computing device to forward the portfolio to the further personal computing device; and
the viewer designating, to the application, a user of the further personal computing device to have the authorization to edit the stored copy of the portfolio.

10. The method of claim 8 wherein the application is a first application that communicates through a communication network with a second application that is executed by the viewer's personal computing device, and wherein the second application facilitates the selecting of the portfolio, the sending of the selection of the portfolio to the first application, the editing of the stored copy of the portfolio, and the identifying, to the first application, the additional viewers to be given the authorization, and wherein the second application is operative on the viewer's personal computing device by a procedure that includes:
downloading the second application over a communication network from an application store to the viewer's personal computing device;
installing the second application on the viewer's personal computing device;
receiving, by the viewer's personal computing device from the viewer, a username and a password that are required for operation of the second application; and
selecting a setting, on the second application, that enables communication between the second application and the first application.

11. The method of claim 4 wherein the sending of the invitation to at least one of the invitees is by bumping of the personal computing device of the application against a personal computing device of the respective invitee.

12. The method of claim 4 wherein the items are images

13. The method of claim 4 wherein the items are books

14. The method of claim 4 wherein the items are audio recordings

15. The method of claim 4 wherein the items are video recordings

16. The method of claim 4, further comprising:
receiving, from the viewer, an identification of an intended recipient to whom the portfolio should be forwarded in a message; and
forwarding the portfolio in a message to the intended recipient.

17. The method of claim 4 wherein the step of receiving from the user includes receiving payment, from the user, for use of the application.

18. The method of claim 4 wherein the portfolio is a first portfolio, and the application enables displaying, on a personal computing device of the viewer, identifiers respectively identifying a set of portfolios including the first portfolio, and wherein the viewer identifies the first portfolio, from among the set, by selecting the identifier that identifies the first portfolio.

19. The method of claim 4 wherein the user is a first user, and the method further comprises the application enabling displaying, on a personal computing device of the viewer, identifiers respectively identifying a set of users including the first user, and wherein the viewer identifies a portfolio of the first user by selecting the identifier that identifies the first user.

20. The method of claim 4 further comprising:
receiving from the user:
a user profile containing personal information regarding the user, and
display settings specifying how the items are to be displayed, including a selection of a template from among templates provided by the application and a selection of placement of the selected items relative to the template;
storing the user profile and the display settings; and
enabling the user, after the sending of the invitation, to edit the stored copy of the portfolio.

21. The method of claim 20 wherein the user profile includes data regarding the user, the data including a name, a password, personal preferences, historical activities, past purchases, financial information, materials to which the user has an affinity, and materials to which the user has an aversion.

22. The method of claim 3 wherein the sending of the invitation to at least one of the additional invitees is via an email from the personal computing device of the application to the respective invitee.

23. The method of claim 10 wherein the first application configures portfolio sharing lists by sending commands to the second application over the Internet or over an intranet, and wherein the portfolio sharing lists correlate portfolio access privileges controlling access rights to individual portfolios, and wherein the second application interprets portfolio access privileges and portfolio sharing lists allowing access to individual portfolios only to authorized users.

24. The method of claim 1 further comprising:
tracking activities, behavior, preferences and habits of the user as the user interacts over time with the application.
